(19) United States
(12) Patent Application Publication
(10) Pub. No.: US 2015/0364969 A1
(43) Pub. Date: Dec. 17, 2015

(54) ELECTROMECHANICAL ACTUATOR AND HOME AUTOMATION INSTALLATION COMPRISING SUCH AN ACTUATOR

(71) Applicant: SOMFY SAS, CLUSES (FR)

(72) Inventor: Adrien BRONDEX, DOMANCY (FR)

(21) Appl. No.: 14/739,001

(22) Filed: Jun. 15, 2015

(30) Foreign Application Priority Data
Jun. 17, 2014 (FR) 1455553

(51) Int. Cl. H02K 7/102; E06B 9/68; E06B 9/72; H02K 7/116

(52) U.S. Cl. CPC H02K 7/102; H02K 7/116; E06B 9/68; E06B 9/72; E06B 2009/725

(57) ABSTRACT

An electromechanical actuator for a home automation closing or sun protection installation includes an electric motor, a reduction gear and a spring-operated brake (15), which includes a helical spring (22), a drum (23), an input member (24) and an output member (25). The drum (23) includes a housing (26). An inner friction surface (27) of the housing (26) of the drum (23) cooperates with at least one turn of the helical spring (22). The spring-operated brake (15) also includes at least one ring (50) positioned between an outer surface (51) of the input member (24) and/or the output member (25) and the inner friction surface (27) of the housing (26) of the drum (23). The home automation installation includes one such actuator.

### FIELD OF THE INVENTION

The present invention relates to an electromechanical actuator. The electromechanical actuator comprises a spring-loaded brake. This type of spring-loaded brake is more particularly suitable for a so-called tubular electromechanical actuator.

The present invention also relates to a home automation installation for closing or sun protection comprising a screen able to be wound on a winding tube rotated by one such electromechanical actuator.

In general, the present invention relates to the field of concealment devices comprising a motorized driving device setting a screen in motion between at least one first position and one second position.

### BACKGROUND OF THE INVENTION

A motorized driving device comprises an electromechanical actuator for a movable element for closing, concealing or providing sun protection such as a shutter, door, grate, blind, or any other equivalent material, hereinafter referred to as a screen.

Document FR 2,610,668 A1 is already known, and describes an electromechanical actuator for a home automation installation for closing or sun protection comprising an electric motor, a reduction gear and a spring-loaded brake.

The spring-loaded brake comprises a helical spring, a drum, an input member and an output member.

Each end of the helical spring forms a tab extending radially relative to an axis of rotation of the spring-loaded brake.

The drum comprises a cylindrical housing. Additionally, an inner friction surface of the housing of the drum cooperates with at least one turn of the helical spring. In this way, at least one turn of the helical spring is radially stressed by the housing of the drum.

The input member is rotated by the electric motor. The input member cooperates with one of the tabs of the helical spring, so as to rotate the helical spring around the axis of rotation of the spring-loaded brake in a first direction of rotation. Such a movement releases the spring-loaded brake. Additionally, the frictional force between the turns of the helical spring and the inner friction surface of the housing of the drum is decreased during rotational driving of the helical spring in the first direction of rotation. In other words, this movement tends to decrease the diameter of the outer enclosure of the helical spring and therefore to decrease the radial stress between the helical spring and the inner friction surface of the housing of the drum.

The output member cooperates with one of the tabs of the helical spring, so as to rotate the helical spring around the axis of rotation of the spring-loaded brake in a second direction of rotation, the second direction of rotation being opposite the first direction of rotation. Such a movement activates the spring-loaded brake. Additionally, the frictional force between the turns of the helical spring and the inner friction surface of the housing of the drum is increased during the rotational driving of the helical spring in the second direction of rotation. In other words, this movement tends to increase the diameter of the outer enclosure of the helical spring, and therefore to increase the radial stress between the helical spring and the inner friction surface of the housing of the drum.

However, this electromechanical actuator has the drawback of creating friction noises related to the rubbing of an outer surface of the input member and/or the output member against the inner friction surface of the housing of the drum.

The unwanted friction between the outer surface of the input member and/or the output member and the inner friction surface of the housing of the drum during rotational driving of the input member and/or the output member inside the housing of the drum is caused by an alignment flaw of the input member and/or the output member relative to the axis of rotation of the spring-loaded brake.

The friction between the outer surface of the input member and/or the output member and the inner friction surface of the housing of the drum is generated by contact of the metal making up the input member and the output member, in particular zamac (acronym for the names of its component metals: zinc, aluminum, magnesium and copper), with the metal making up the drum, in particular a sintered steel.

Consequently, such rubbing between the outer surface of the input member and/or the output member and the inner friction surface of the housing of the drum is detrimental to the acoustic level of the electromechanical actuator during its operation.

### SUMMARY OF THE INVENTION

The present invention aims to resolve the aforementioned drawbacks and to propose an electromechanical actuator provided with a spring-loaded brake making it possible to reduce the friction noises of the spring-loaded brake during the rotational driving of the input member and/or the output member inside the housing of the drum.

To that end, according to a first aspect, the present invention relates to an electromechanical actuator for a home automation closing or sun protection installation comprising an electric motor, a reduction gear and a spring-loaded brake, said spring-loaded brake comprising:
a helical spring;
a drum, where the drum comprises a housing, and where an inner friction surface of the housing of the drum cooperates with at least one turn of the helical spring;
an input member;
an output member.

According to the invention, the spring-loaded brake also comprises at least one ring positioned between an outer surface of the input member and/or the output member and the inner friction surface of the housing of the drum.

Thus, said at least one ring positioned between the outer surface of the input member and/or the output member and the inner friction surface of the housing of the drum makes it possible to reduce the operating noises from the spring-loaded brake during rotational driving of the input member and/or the output member inside the housing of the drum.

In this way, said at least one ring makes it possible to eliminate the operating noises of the spring-loaded brake related to the rubbing of the outer surface of the input member and/or the output member against the inner friction surface of the housing of the drum, since the input member and/or the output member can no longer be in direct contact with the inner friction surface of the housing of the drum.

Consequently, said at least one ring positioned between the outer surface of the input member and/or the output member and the inner friction surface of the housing of the drum allows sliding without direct contact of the input member and/or the output member against the housing of the drum, during the rotational driving of the input member and/or the output member relative to the housing of the drum.

In this way, said at least one ring positioned between the outer surface of the input member and/or the output member and the inner friction surface of the housing of the drum acts as a bearing between the input member and/or the output member and the housing of the drum.

Furthermore, said at least one ring positioned between the outer surface of the input member and/or the output member and the inner friction surface of the housing of the drum makes it possible to make up for the alignment flaws between the input member and/or the output member relative to the axis of rotation of the spring-loaded brake, so as to avoid placing the input member and the output member in contact with the inner friction surface of the housing of the drum, which may create operating noises of the spring-loaded brake.

Practically, said at least one ring is made from plastic material.

According to one preferred feature of the invention, the input member and/or the output member comprises a housing, and said at least one ring is positioned at said housing.

Preferably, the housing of the input member and/or the output member is a shoulder, and said at least one ring is kept in position along the axis of rotation of the spring-loaded brake between the shoulder of the input member and/or the output member and a shoulder of the drum.

According to another preferred feature of the invention, said at least one ring has a thickness greater than the depth of the housing arranged in the input member and/or in the output member, and one of the side faces of the ring cooperates with the shoulder of the drum.

According to another preferred feature of the invention, the drum, the input member and the output member are parts of revolution, and the outer diameter of said at least one ring is larger than the outer diameters of the input member and the output member.

Practically, the input member and the output member are made from zamac and the drum is made from steel, in particular sintered steel.

According to another preferred feature of the invention, the inner diameter of the housing of the drum at the inner friction surface of the housing of the drum is larger than the outer diameter of said at least one ring.

According to a second aspect, the invention relates to a home automation installation for closing or providing sun protection that comprises a screen able to be wound on a winding tube rotated by an electromechanical actuator according to the invention.

This home automation installation has features and advantages similar to those previously described relative to the electromechanical actuator described above.

Other particularities and advantages of the invention will also appear in the description below.

### BRIEF DESCRIPTION OF THE DRAWINGS

In the appended drawings, provided as non-limiting examples:

FIG. 1 is a sectional diagrammatic view of a home automation installation according to one embodiment of the invention;

FIG. 2 is a diagrammatic perspective view of the home automation installation illustrated in FIG. 1;

FIG. 3 is a diagrammatic partial sectional view of the home automation installation illustrated in FIG. 2 comprising an electromechanical actuator;

FIG. 4 is an exploded diagrammatic view of a spring-loaded brake of the electromechanical actuator illustrated in FIG. 3;

FIG. 5 is a diagrammatic sectional view of the spring-loaded brake illustrated in FIG. 4;

FIG. 6 is a diagrammatic perspective view of the spring-loaded brake illustrated in FIGS. 4 and 5, where the spring-loaded brake has been removed;

FIG. 7 is a diagrammatic front view of the spring-loaded brake illustrated in FIG. 6.

### DETAILED DESCRIPTION OF THE INVENTION

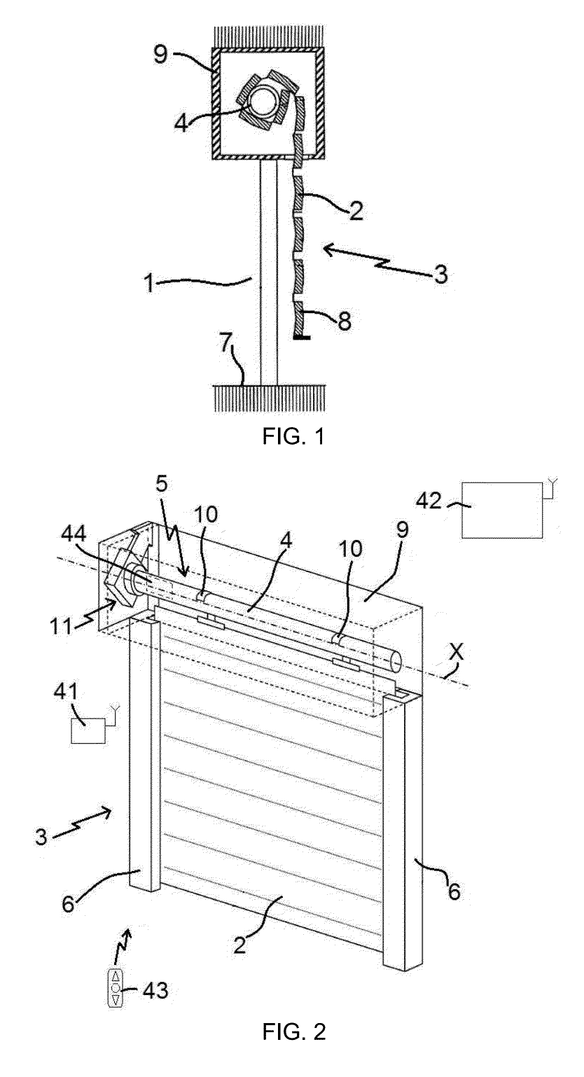

In reference to FIGS. 1 and 2, we will first describe a home automation installation according to the invention and installed in a building comprising an opening 1, window or door, equipped with a screen 2 belonging to a concealing device 3, in particular a motorized rolling shutter.

The concealing device 3 can be a rolling shutter, as illustrated in FIGS. 1 and 2, a canvas blind or blinds with adjustable slats, or a rolling gate. The present invention applies to all types of concealing devices.

The screen 2 of the concealing device 3 is wound on a winding tube 4 driven by a motorized driving mechanism 5 and movable between a wound position, in particular an upper position, and an unwound position, in particular a lower position.

The motorized driving mechanism 5 comprises an electromechanical actuator 11, in particular of the tubular type, making it possible to set the winding tube 4 of the concealing device 3 in rotation so as to unwind or wind the screen 2 of the concealing device 3.

In the mounted state, the electromechanical actuator 11 is inserted into the winding tube 4.

The electromechanical actuator 11 comprises a casing 13, which is preferably cylindrical.

In a known manner, a rolling shutter 3 comprises an apron comprising horizontal slats articulated on one another, forming the screen 2 of the rolling shutter 3, and guided by two lateral guideways 6. These slats are joined when the apron 2 of the rolling shutter 3 reaches its unwound lower position.

In the case of a rolling shutter, the wound upper position corresponds to the bearing of a final L-shaped end slat 8 of the apron 2 of the rolling shutter 3 against an edge of a box 9 of the rolling shutter 3, and the unwound lower position corresponds to the bearing of the final end slat 8 of the apron 2 of the rolling shutter 3 against a threshold 7 of the opening 1.

The first slat of the rolling shutter 3, opposite the end slat, is connected to the winding tube 4 using at least one articulation 10.

The winding tube 4 is positioned inside the box 9 of the rolling shutter 3. The apron 2 of the rolling shutter 3 winds and unwinds around the rolling tube 4 and is housed at least partially inside the box 9.

The motorized driving mechanism 5 is commanded by a control unit. The control unit may for example be a local control unit 41, where the local control unit 41 can be connected through a wired or wireless connection with a central control unit 42. The central control unit 42 drives the local control unit 41, as well as other similar local control units distributed throughout the building.

The central control unit 42 can be in communication with a weather station located outside the building, in particular including one or more sensors that can be configured for example to determine the temperature, brightness, or wind speed.

A remote control 43, which can be a type of local control unit, and provided with a control keypad, which comprises selection and display means, further allows a user to intervene on the electromechanical actuator 11, the local control unit 41 and/or the central control unit 42.

The motorized driving mechanism 5 is preferably configured to carry out the unwinding or winding commands of the screen 2 of the concealing device 3, which may in particular be acquired by the remote control 43. Control means for controlling the electromechanical actuator 11 according to the invention, making it possible to move the screen 2 of the concealing device 3, are made up of at least one electronic control unit 44. This electronic control unit 44 is able to operate an electric motor 12 of the electromechanical actuator 11, and in particular to allow the supply of electricity for the electric motor 12.

Thus, the electronic control unit 44 in particular controls the electric motor 12, so as to open or close the screen 2, as previously described.

The electronic control unit 44 also comprises an order receiving module, in particular for wireless orders sent by an order transmitter such as the remote control 43 designed to control the electromechanical actuator 11.

Of course, the order receiving module can also allow the reception of orders sent by wired means.

Here, and as illustrated in FIG. 2, the electronic control unit 44 is positioned inside a casing 13 of the electromechanical actuator 11.

The control means of the electromechanical actuator 11 comprise hardware and/or software means.

As one non-limiting example, the hardware means may comprise at least one microcontroller.

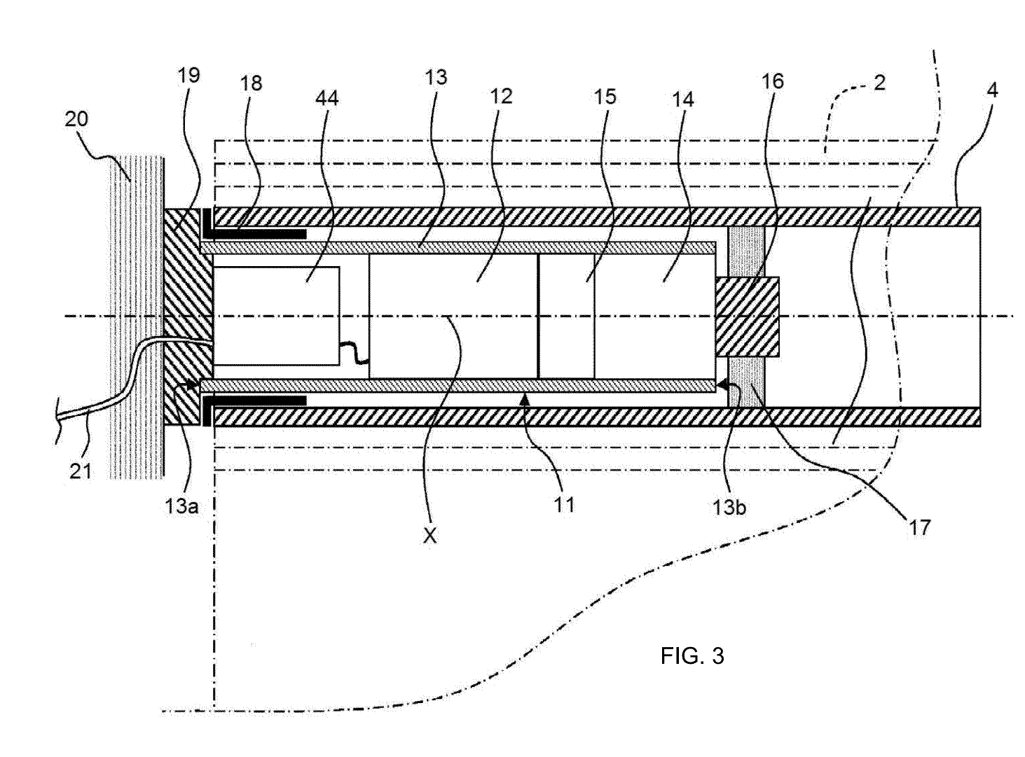

We will now describe, in reference to FIG. 3, a method for manufacturing an electromechanical actuator according to one embodiment of the invention.

The electromechanical actuator 11 is supplied with electricity by the electricity grid of the sector, or using a battery, which can for example be recharged by a photovoltaic panel. The electromechanical actuator 11 makes it possible to move the screen 2 of the concealing device 3.

The moving screen 2 of the concealing device 3 is a closing, concealing and/or sun protection screen, winding on the winding tube 4, the inner diameter of which is substantially equivalent to the outer diameter of the electromechanical actuator 11, such that the electromechanical actuator 11 can be inserted into the winding tube 4 during the assembly of the concealing device 3.

In another embodiment that is not shown, the electromechanical actuator 11 is designed to be placed in a U-shaped profiled rail.

The winding tube 4 is rotated around an axis of rotation X and the casing 13 of the electromechanical actuator 11 supported by two pivot links. The first pivot link is produced at a first end of the winding tube 4 using a crown 18 inserted around and at one end 13a of the casing 13 of the electromechanical actuator 11. The crown 18 thus makes it possible to produce a bearing. The second pivot link, not shown in FIG. 3, is produced at a second end of the winding tube 4.

The electromechanical actuator 11 comprises a torque support 19. The torque support 19 protrudes at one end 13a of the casing 13 of the electromechanical actuator 11, in particular the end 13a of the casing 13 receiving the crown 18. The torque support 19 of the electromechanical actuator 11 thus makes it possible to fasten the electromechanical actuator 11 on a housing 20, in particular a flange of the box 9.

Furthermore, the torque support 19 of the electromechanical actuator 11 can make it possible to close off the end 13a of the casing 13.

Furthermore, the torque support 19 of the electromechanical actuator 11 can make it possible to support the electronic control unit 44. The electronic control unit 44 can be supplied with electricity via a power cable 21 electrically connected to the electricity grid of the sector, or a battery.

The electromechanical actuator 11 comprises an electric motor 12. The motor 12 comprises a rotor and a stator positioned coaxially around the axis of rotation X.

The electromechanical actuator 11 comprises a reduction gear 14. The reduction gear 14 comprises at least one reduction stage. Said at least one reduction stage can be a gear train of the epicyclic type.

Of course, the type and number of reduction stages of the reduction gear are in no way limiting.

The electromechanical actuator 11 comprises an output shaft 16. One end of the output shaft 16 protrudes relative to the casing 13 of the electromechanical actuator 11, in particular relative to an end 13b of the casing 13 opposite the end 13a of the casing 13.

The output shaft 16 of the electromechanical actuator 11 rotates a connecting element 17 connected to the winding tube 4. The connecting element 17 is made in the form of a wheel.

When the electromechanical actuator 11 is operated, the electric motor 12 and the reduction gear 14 rotate the output shaft 16. Additionally, the output shaft 16 of the electromechanical actuator 11 rotates the winding tube 4 via the connecting element 17. Thus, the winding tube 4 rotates the screen 2 of the concealing device 3 so as to open or close the opening 1.

The electromechanical actuator 11 comprises a spring-loaded brake 15.

The electric motor 12, the reduction gear 14 and the spring-loaded brake 15 are mounted inside the casing 13 of the electromechanical actuator 11.

In the embodiment illustrated in FIG. 3, the spring-loaded brake 15 is positioned between the electric motor 12 and the reduction gear 14, i.e., at the output of the electric motor 12.

In another embodiment that is not shown, where the reduction gear 14 comprises a plurality of reduction stages, the spring-loaded brake 15 is positioned between two reduction stages of the reduction gear 14.

In another embodiment that is not shown, the spring-loaded brake 15 is positioned at the output of the reduction gear 14.

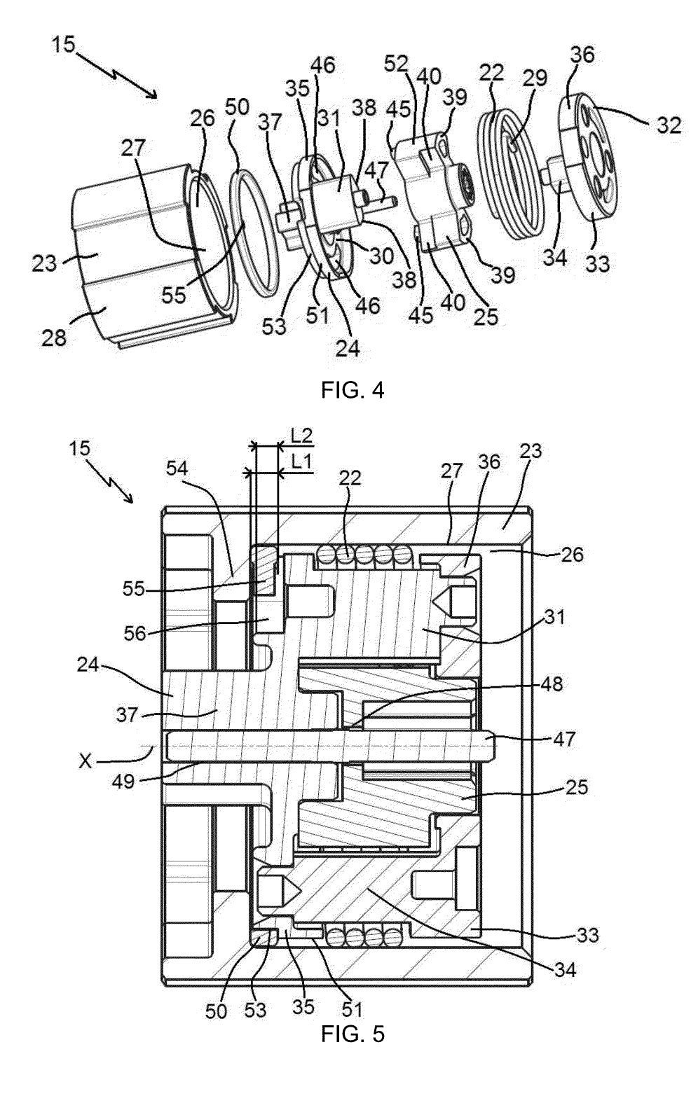

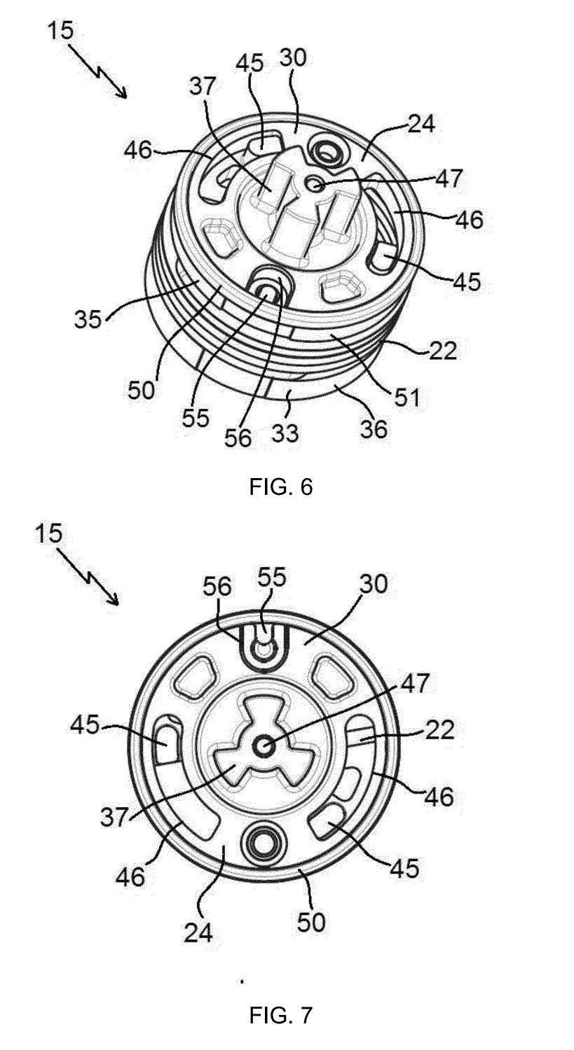

A spring-loaded brake of the electromechanical actuator 11 according to one embodiment of the invention will now be described in reference to FIGS. 4 to 7.

The spring-loaded brake 15 comprises at least one helical spring 22, a drum 23, an input member 24 and an output member 25.

The drum 23 is kept in position in the casing 13 of the electromechanical actuator 11, in particular using ribs 28 arranged on the outer periphery of the drum 23 cooperating with tongues (not shown) of a housing of the reduction gear 14. Additionally, the housing of the reduction gear 14 is kept in position in the casing 13 of the electromechanical actuator 11.

The drum 23 comprises a housing 26. Here, the housing 26 of the drum 23 is cylindrical.

The helical spring 22, the input member 24 and the output member 25 are positioned inside the housing 26 of the drum 23. The output member 25 is positioned across from the input member 24.

Here, the helical spring 22 comprises a plurality of turns. The turns of the helical spring 22 are centered on an axis combined with the axis of rotation X when the spring-loaded brake 15 is assembled, then mounted in the electromechanical actuator 11. Likewise, the input member 24 and the output member 25 are centered on an axis combined with the axis of rotation X when the spring-loaded brake 15 is assembled, then mounted in the electromechanical actuator 11.

An inner friction surface 27 of the housing 26 of the drum 23 cooperates with at least one turn of the helical spring 22. In this way, at least one turn of the helical spring 22 is radially stressed by the housing 26 of the drum 23.

Here, the helical spring 22 is mounted tightly inside the housing 26 of the drum 23, so as to secure the helical spring 22 and the drum 23 by friction when the helical spring 22 is idle.

Each end of the helical spring 22 forms a tab 29 extending radially or axially relative to the axis of rotation X of the spring-loaded brake 15.

Here, the helical spring 22 comprises two tabs 29, only one of which is visible in FIG. 4.

In the embodiment illustrated in FIG. 4, the tabs 29 of the helical spring 22 extend radially relative to the axis of rotation X of the spring-loaded brake 15 and toward the inside of the helical spring 22, in particular from the turns of the helical spring 22 toward the central axis of the helical spring 22.

The input member 24 is rotated by the electric motor 12.

Here, and as illustrated in FIGS. 4 to 7, the input member 24 comprises a shaft 37. The shaft 37 of the input member 24 makes it possible to receive and transmit torque coming from the electric motor 12.

In the embodiment illustrated in FIGS. 4 and 5, the input member 24 comprises a driving tooth 31. The driving tooth 31 of the input member 24 is inserted inside the helical spring 22, when the spring-loaded brake 15 is assembled.

The input member 24 also comprises a first plate 30.

Here, the first plate 30 comprises the driving tooth 31.

The driving tooth 31 of the input member 24 is positioned between the two tabs 29 of the helical spring 22 and cooperates with one or the other of the tabs 29 of the helical spring 22, depending on the direction of rotation generated by the electric motor 12.

The driving tooth 31 of the input member 24 comprises two driving faces 38. Each driving face 38 of the driving tooth 31 cooperates with the tab 29 of the helical spring 22.

Here, and as illustrated in FIGS. 4 and 5, the helical spring 22 and the output member 25 are kept axially in position between the first plate 30 of the input member 24 and a second plate 32 of a cover 33.

Here, and as illustrated in FIG. 4, the second plate 32 of the cover 33 comprises a spacer 34, positioned diametrically opposite the driving tooth 31 of the first plate 30 relative to the axis of rotation X when the spring-loaded brake 15 is assembled. The spacer 34 of the second plate 32 of the cover 33 thus makes it possible to maintain an axial separation between the first and second plates 30, 32.

In another embodiment that is not shown, the first plate 30 of the input member 24 may comprise the spacer 34.

Here and as illustrated in FIGS. 4 and 5, the first and second plates 30, 32 each comprise a peripheral collar 35, 36. The two peripheral collars 35, 36 are positioned across from one another along the axis of rotation X of the spring-loaded brake 15. The first and second plates 30, 32 are secured in rotation around the axis of rotation X of the spring-loaded brake 15.

In one embodiment, the first and second plates 30, 32 can be kept secured in rotation around the axis of rotation X of the spring-loaded brake 15 by simple fitting.

In another embodiment, the first and second plates 30, 32 can be kept secured in rotation around the axis of rotation X of the spring-loaded brake 15 by fastening using a fastening element, such as a fastening screw.

The output member 25 is connected to the screen 2 of the concealing device 3.

In the embodiment illustrated in FIGS. 4 and 5, the output member 25 comprises two lugs 39. The lugs 39 of the output member 25 are inserted inside the helical spring 22, when the spring-loaded brake 15 is assembled.

The lugs 39 of the output member 25 respectively comprise a recess 40. The recess 40 of each of the lugs 39 of the output member 25 cooperates with one of the tabs 29 of the helical spring 22.

The lugs 39 of the output member 25 further respectively comprise a protruding element 45. The protruding element 45 of each of the lugs 39 of the output member 25 extends along the axis of rotation X of the spring-loaded brake 15, and in particular toward the input member 24 when the spring-loaded brake 15 is assembled. The protruding element 45 of each of the lugs 39 of the output member 25 cooperates with an aperture 46 of the input member 24, when the spring-loaded brake 15 is assembled.

In one embodiment, the peripheral face of the protruding element 45 of one of the lugs 39 of the output member 25 can be put in contact with the contour of the corresponding aperture 46 of the input member 24 when one of the driving faces 38 of the driving tooth 31 of the input member 24 is in contact with the face of the corresponding lug 39 of the output member 25.

Here, and as illustrated in FIGS. 4 and 5, the output member 25 is centered relative to the input member 24 using an axle 47. The axle 47 is inserted on the one hand into a bore 48 of the output member 25 and on the other hand into a bore 49 of the input member 24.

The input member 24, in particular the driving tooth 31, operates with at least one of the tabs 29 of the helical spring 22 so as to rotate the helical spring 22 around the axis of rotation X of the spring-loaded brake 15 in a first direction of rotation.

Such a movement releases the spring-loaded brake 15.

Additionally, the friction force between at least one turn of the helical spring 22 and the inner friction surface 27 of the housing 26 of the drum 23 is decreased during the rotational driving of the helical spring 22 in the first direction of rotation.

In other words, this movement tends to decrease the diameter of the outer enclosure of the helical spring 22, and therefore to decrease the radial stress between the helical spring 22 and the inner friction surface 27 of the housing 26 of the drum 23.

Thus, the movement generated by the electric motor 12 can be transmitted from the input member 24 to the output member 25.

The outer enclosure of the helical spring 22 is defined by the outer generatrices of the turns of the helical spring 22.

The output member 25, in particular one of the lugs 39, cooperates with at least one of the tabs 29 of the helical spring 22 so as to rotate the helical spring 22 around the axis of rotation X of the spring-loaded brake 15 in a second direction of rotation.

Such a movement activates the spring-loaded brake 15, i.e., tends to block or slow the rotation of the helical spring 22 inside the housing 26 of the rotating drum 23.

Additionally, the friction force between at least one turn of the helical spring 22 and the inner friction surface 27 of the housing 26 of the drum 23 is increased during the rotational driving of the helical spring 22 in the second direction of rotation.

In other words, this movement tends to increase the diameter of the outer enclosure of the helical spring 22, in particular by bringing the tabs 29 of the helical spring 22 closer together, and therefore to increase the radial stress between the helical spring 22 and the inner friction surface 27 of the housing 26 of the drum 23.

As illustrated in FIGS. 4 to 7, the spring-loaded brake 15 also comprises a ring 50 positioned between an outer surface 51 of the input member 24 and the inner friction surface 27 of the housing 26 of the drum 23.

Thus, the ring 50 positioned between the outer surface 51 of the input member 24 and the inner friction surface 27 of the housing 26 of the drum 23 makes it possible to reduce the operating noises of the spring-loaded brake 15 during the rotational driving of the input member 24 and/or the output member 25 inside the housing 26 of the drum 23.

In this way, the ring 50 makes it possible to eliminate the operating noises of the spring-loaded brake 15 related to the rubbing of the outer surface 51 of the input member 24 against the inner friction surface 27 of the housing 26 of the drum 23, since the input member 24 can no longer be in direct contact with the inner friction surface 27 of the housing 26 of the drum 23, in a radial direction.

Consequently, the ring 50 positioned between the outer surface 51 of the input member 24 and the inner friction surface 27 of the housing 26 of the drum 23 allows sliding, without direct contact, of the input member 24 against the housing 26 of the drum 23, during rotational driving of the input member 24 relative to the housing 26 of the drum 23.

In this way, the ring 50 positioned between the outer surface 51 of the input member 24 and the inner friction surface 27 of the housing 26 of the drum 23 serves as a bearing between the input member 24 and the housing 26 of the drum 23.

Furthermore, the ring 50 positioned between the outer surface 51 of the input member 24 and the friction member 27 of the housing 26 of the drum 23 makes it possible to make up for alignment flaws of the input member 24 and/or the output member 25 relative to the axis of rotation X of the spring-loaded brake 15, so as to avoid putting the input member 24 and the output member 25 in contact with the inner friction surface 27 of the housing 26 of the drum 23, which may create operating noises of the spring-loaded brake 15.

In another embodiment that is not shown, the spring-loaded brake 15 comprises a ring 50 positioned between an outer surface 52 of the output member 25 and the inner friction surface 27 of the housing 26 of the drum 23 by replacing the ring 50 positioned between the outer surface 51 of the input member 24 and the inner friction surface 27 of the housing 26 of the drum 23.

Similarly to the embodiment shown in FIGS. 4 to 7, the ring 50 positioned between the outer surface 52 of the output member 25 and the inner friction surface 27 of the housing 26 of the drum 23 makes it possible to reduce the operating noises of the spring-loaded brake 15 during the rotational driving of the input member 24 and/or the output member 25 inside the housing 26 of the drum 23.

In that case, the ring 50 positioned between the outer surface 52 of the output member 25 and the friction member 27 of the housing 26 of the drum 23 makes it possible to make up for alignment flaws of the output member 25 and/or the input member 24 relative to the axis of rotation X of the spring-loaded brake 15, so as to avoid putting the input member 24 and the output member 25 in contact with the inner friction surface 27 of the housing 26 of the drum 23, which may create operating noises of the spring-loaded brake 15.

In another embodiment that is not shown, the spring-loaded brake 15 comprises a first ring 50 positioned between an outer surface 51 of the input member 24 and the inner friction surface 27 of the housing 26 of the drum 23, and a second ring 50 positioned between an outer surface 52 of the output member 25 and the inner friction surface 27 of the housing 26 of the drum 23.

Similarly to the two previous embodiments, the first and second rings 50 positioned respectively between the outer surface 51 of the input member 24 and the inner friction surface 27 of the housing 26 of the drum 23 on the one hand, and between the outer surface 52 of the output member 25 and the inner friction surface 27 of the housing 26 of the drum 23 on the other hand, make it possible to reduce the operating noises of the spring-loaded brake 15 during the rotational driving of the input member 24 and/or the output member 25 inside the housing 26 of the drum 23.

In that case, the first and second rings 50 respectively positioned between the outer surface 51 of the input member 24 and the inner friction surface 27 of the housing 26 of the drum 23 on the one hand, and between the outer surface 52 of the output member 25 and the inner friction surface 27 of the housing 26 of the drum 23 on the other hand, make it possible to make up for the alignment flaws of the input member 24 and the output member 25 relative to the axis of rotation X of the spring-loaded brake 15 so as to avoid putting the input member 24 and the output member 25 in contact with the inner friction surface 27 of the housing 26 of the drum 23, which may create operating noises of the spring-loaded brake 15.

Practically, irrespective of the embodiment, the ring 50 is made from plastic material.

Thus, the ring 50 positioned between the outer surface 51, 52 of the input member 24 and/or the output member 25 and the inner friction surface 27 of the housing 26 of the drum 23 makes it possible to produce a bearing, so as to guarantee the sliding between the input member 24 and/or the output member 25 and the drum 23 without direct contact, during the rotational driving of the input member 24 and/or the output member 25 relative to the housing 26 of the drum 23.

As a non-limiting example, the plastic material of the ring 50 can be polyoxyethylene (POM).

In one embodiment, the input member 24 and the output member 25 are made from zamac (acronym for the names of the component metals: zinc, aluminum, magnesium and copper), and the drum 23 is made from steel, in particular sintered steel. Thus, the use of zamac to produce the input member 24 and the output member 25 makes it possible to guarantee good precision of the dimensions of those parts when they are manufactured. Additionally, using sintered steel to produce the drum 23 makes it possible to decrease the resistance to rubbing against the inner friction surface 27 of the housing 26 of the drum 23.

Advantageously, the input member 24 comprises a housing 53, where the ring 50 is positioned at the housing 53.

Thus, the ring 50 is positioned axially relative to the input member 24 using the housing 53 along the axis of rotation X of the spring-loaded brake 15.

Similarly, in the embodiment where the spring-loaded brake 15 comprises a ring 50 positioned between the outer surface 52 of the output member 25 and the inner friction surface 27 of the housing 26 of the drum 23, the output member 25 comprises a housing that is not shown, where the ring 50 is positioned at the housing.

Preferably, the housing 53 or equivalent means of the input member 24 and/or the output member 25 is a shoulder.

In the embodiment illustrated in FIGS. 4 to 7, the ring 50 is kept in position along the axis of rotation X of the spring-loaded brake 15 between the shoulder 53 of the input member 24 and a shoulder 54 of the drum 23.

Thus, the ring 50 is kept in position along the axis of rotation X of the spring-loaded brake 15 between the first shoulder 53 of the input member 24 and the second shoulder 54 of the drum 23.

Similarly, in the embodiment where the spring-loaded brake 15 comprises a ring 50 positioned between the outer surface 52 of the output member 25 and the inner friction surface 27 of the housing 26 of the drum 23, the ring 50 is kept in position along the axis of rotation X of the spring-loaded brake 15 between the shoulder of the output member 25 and a shoulder of the drum 23.

Advantageously, the ring 50 has a thickness L1 greater than the depth L2 of the housing 53 arranged in the input member 24, along the axis of rotation X of the spring-loaded brake 15.

Additionally, one of the side faces of the ring 50 cooperates with the shoulder 54 of the drum 23, in particular with the side face of the shoulder 54 of the drum 23, the side face of the shoulder 54 of the drum 23 being orthogonal to the axis of rotation X of the spring-loaded brake 15.

Thus, the excess thickness L1 of the ring 50 relative to the depth L2 of the housing 53 arranged in the input member 24 makes it possible to avoid direct contact between the input member 24 and the drum 23 in an axial direction, and consequently to reduce the operating noise of the spring-loaded brake 15 during the rotational driving of the input member 24 inside the housing 26 of the drum 23.

In this way, the ring 50 makes it possible to eliminate the operating noises of the spring-loaded brake 15 related to the rubbing of the outer surface of the first plate 30 of the input member 24 against the shoulder 54 of the drum 23, since the input member 24 can no longer be in direct contact with the shoulder 54 of the drum 23, in an axial direction.

Consequently, the ring 50 positioned between the outer surface of the first plate 30 of the input member 24 and the shoulder 54 of the drum 23 also allows sliding with no direct contact of the input member 24 against the housing 26 of the drum 23, during rotational driving of the input member 24 relative to the housing 26 of the drum 23.

Similarly, in the embodiment where the spring-loaded brake 15 comprises a ring 50 positioned between the outer surface 52 of the output member 25 and the inner friction member 27 of the housing 26 of the drum 23, the ring 50 has a thickness greater than the depth of the housing arranged in the output member 25, along the axis of rotation X of the spring-loaded brake 15.

Additionally, one of the side faces of the ring 50 cooperates with the shoulder of the drum 23, in particular with a side face of the shoulder of the drum 23, the side face of the shoulder of the drum 23 being orthogonal to the axis of rotation X of the spring-loaded brake 15.

Advantageously, the ring 50 comprises a rotational locking element 55. The rotational locking element 55 of the ring 50 cooperates with an opening 56 arranged in the input member 24.

In this way, the anti-rotation device of the ring 50 relative to the input member 24 makes it possible to avoid premature wear of the ring 50 related to rubbing of the ring 50 on the outer surface 51 of the input member 24, in particular when the input member 24 is made from a material such as zamac.

Here, and as illustrated in FIGS. 4 to 7, the rotation-locking element 55 of the ring 50 is a tongue extending from the annulus making up the ring 50 toward the center of the ring 50. Additionally, the opening 56 arranged in the input member 24, in particular in the first plate 30, cooperates with the tongue forming the rotational locking element 55 of the ring 50.

Similarly, in the embodiment where the spring-loaded brake 15 comprises a ring 50 positioned between the outer surface 52 of the output member 25 and the inner friction surface 27 of the housing 26 of the drum 23, the ring 50 comprises a rotational locking element that is not shown. The rotational locking element of the ring 50 cooperates with an opening arranged in the input member 25.

Practically, the drum 23, the input member 24 and the output member 25 are parts of revolution.

The outer diameter of the ring(s) 50 is larger than the outer diameter of the input member 24 and the outer diameter of the output member 25.

Thus, the ring(s) 50 positioned between the outer surface 51 of the input member 24 and the inner friction surface 27 of the housing 26 of the drum 23 and/or between the outer surface 52 of the output member 25 and the inner friction surface 27 of the housing 26 of the drum 23 make it possible to avoid direct contact between the input member 24 and the housing 26 of the drum 23, and between the output member 25 and the housing 26 of the drum 23, by interposing the ring(s) 50 between them.

In this way, the pivot link between the input member 24 and the housing 26 of the drum 23 and between the output member 25 and the housing 26 of the drum 23 is implemented by means of the ring(s) 50, so as to guarantee sliding limiting the operating noises of the spring-loaded brake 15 during the rotational driving of the input member 24 and/or the output member 25 inside the housing 26 of the drum 23.

In one embodiment, the inner diameter of the housing 26 of the drum 23 at the inner friction surface 27 of the housing 26 of the drum 23 is larger than the outer diameter of the ring(s) 50.

Thus, the ring(s) 50 can be mounted with free adjustment inside the housing 26 of the drum 23.

In another embodiment, the inner diameter of the housing 26 of the drum 23 at the inner friction surface 27 of the housing 26 of the drum 23 is smaller than the outer diameter of the ring(s) 50.

Thus, the ring(s) 50 can be mounted with tight adjustment inside the housing 26 of the drum 23.

In this way, an operating play of the spring-loaded brake 15 is eliminated.

Consequently, the ring(s) 50 can be pre-mounted inside the housing 26 of the drum 23 so as to avoid removal of the ring 50 in the direction of the axis of rotation X of the spring-loaded brake 15.

Owing to the present invention, the ring(s) positioned between the outer surface of the input member and/or the output member and the inner friction surface of the housing of the drum make it possible to reduce the operating noises from the spring-loaded brake during the rotational driving of the input member and/or the output member inside the housing of the drum.

Of course, many changes can be made to the example embodiment previously described without going beyond the scope of the invention.

In particular, the ring can be attached on or be an integral part of the input member and/or the output member, in particular in the case of an electromechanical actuator having an electric motor providing a low torque. In such a case, the ring and the input member and/or the output member form a single sub-assembly or a single part, for example made from plastic material.

The embodiments and alternatives considered above may be combined to generate new embodiments. The embodiments and alternatives described above may be combined to create new embodiments of the invention.

1. An electromechanical actuator for a home automation closing or sun protection installation comprising an electric motor, a reduction gear and a spring-loaded brake, said spring-loaded brake comprising:
a helical spring;
a drum;
where the drum comprises a housing, and
where an inner friction surface of the housing of the drum cooperates with at least one turn of the helical spring;
an input member;
an output member;
wherein the spring-loaded brake also comprises at least one ring positioned between an outer surface of the input member and/or the output member and the inner friction surface of the housing of the drum.

2. The electromechanical actuator for a home automation closing or sun protection installation according to claim 1, wherein said at least one ring is made from plastic material.

3. The electromechanical actuator for a home automation closing or sun protection installation according to claim 1, wherein the input member and/or the output member comprises a housing, and wherein said at least one ring is positioned at said housing.

4. The electromechanical actuator for a home automation closing or sun protection installation according to claim 3, wherein the housing of the input member and/or the output member is a shoulder, and wherein said at least one ring is kept in position along the axis of rotation of the spring-loaded brake between the shoulder of the input member and/or the output member and a shoulder of the drum.

5. The electromechanical actuator for a home automation closing or sun protection installation according to claim 4, wherein said at least one ring has a thickness greater than the depth of the housing arranged in the input member and/or in the output member and in that one of the side faces of the ring cooperates with the shoulder of the drum.

6. The electromechanical actuator for a home automation closing or sun protection installation according to claim 1, wherein said at least one ring comprises a rotational locking element, and wherein the rotational locking element of said at least one ring cooperates with an opening arranged in the input member and/or the output member.

7. The electromechanical actuator for a home automation closing or sun protection installation according to claim 1, wherein the drum, the input member and the output member are parts of revolution, and wherein the outer diameter of said at least one ring is larger than the outer diameters of the input member and the output member.

8. The electromechanical actuator for a home automation closing or sun protection installation according to claim 1, wherein the input member and the output member are made from zamac and the drum is made from steel, in particular sintered steel.

9. The electromechanical actuator for a home automation closing or sun protection installation according to claim 1, wherein the inner diameter of the housing of the drum at the inner friction surface of the housing of the drum is larger than the outer diameter of said at least one ring.

10. A home automation installation for closing or providing sun protection that comprises a screen able to be wound on a winding tube rotated by an electromechanical actuator, wherein the electromechanical actuator is according to claim 1.
